(19) United States
(12) Patent Application Publication
(10) Pub. No.: US 2011/0136424 A1
(43) Pub. Date: Jun. 9, 2011

(54) AIR CONDITIONING SYSTEM FOR ELECTRIC VEHICLE AND METHOD FOR CONTROLLING THE SAME

(75) Inventors: June Kyu Park, Hwaseong (KR); Hee Sang Park, Hwaseong (KR); Hun Soo Kim, Bucheon (KR); Jung Hwan Yun, Seoul (KR); Hyun Kim, Hwaseong (KR); Hee Jun Jeong, Hwaseong (KR)

(73) Assignee: HYUNDAI MOTOR COMPANY, Seoul (KR)

(21) Appl. No.: 12/852,819

(22) Filed: Aug. 9, 2010

(30) Foreign Application Priority Data
Dec. 3, 2009 (KR) 10-2009-0118890

(51) Int. Cl. B60H 1/00; B60H 1/34; B60H 1/22

(52) U.S. Cl. 454/75; 454/152; 454/159

(57) ABSTRACT

The present invention provides an air conditioning system for an electric vehicle and a method of controlling the air conditioning system. According to preferred embodiments, the air conditioning system includes a blower, a battery and a Motor Control Unit (MCU), and a controller.

### CROSS-REFERENCE TO RELATED APPLICATION

This application claims under 35 U.S.C. §119(a) the benefit of Korean Patent Application No. 10-2009-0118890 filed Dec. 3, 2009, the entire contents of which are incorporated herein by reference.

### BACKGROUND

(a) Technical Field

The present disclosure relates in general to an air conditioning system for an electric vehicle. More particularly, it relates to an air conditioning system for an electric vehicle wherein, when an electric vehicle is driven using electrical energy, it is capable of efficiently heating the interior of the vehicle and, in particular, is capable of reducing the consumption of battery power, thereby being able to suitably improve the traveling distance and fuel economy of the vehicle.

(b) Background Art

Today gasoline and diesel engines using fossil fuel produce many problems, such as environmental pollution caused by exhaust gas, global warming caused by carbon dioxide, and may contribute to respiratory diseases caused by the generation of ozone. Furthermore, since fossil fuel present in the earth is limited, there is the risk of resources being exhausted in the future.

In order to overcome these problems, electric vehicles, such as a pure Electric Vehicle (EV) which is driven by operating an electric motor, a Hybrid Electric Vehicle (HEV) which is driven by both an engine and an electric motor, and a Fuel Cell Electric Vehicle (FCEV), which is driven by operating an electric motor using power produced by a fuel cell, have been developed.

Such an electric vehicle includes an electric motor for driving the vehicle, a battery for functioning as an electricity accumulation means for supplying power to the electric motor, and an inverter for operating the electric motor. In the case of a fuel cell vehicle, an electricity accumulation means, such as a battery, is used as an auxiliary power source which is connected in parallel with a fuel cell, that is, a primary power source. A fuel cell hybrid system which is equipped with a supercapacitor instead of a battery as an auxiliary power source is being developed. The inverter changes the phase of power supplied from an electricity accumulation means or a fuel cell in response to control signals applied by a controller and then operates the electric motor using it.

Accordingly, an electric vehicle has been provided with a heating apparatus for heating the interior of the vehicle and, recently, has been further provided with an air purifying apparatus for keeping the interior air of the vehicle comfortable.

A heating apparatus using the power of a battery may be used as the heating apparatus of an electric vehicle. An example of the heating apparatus is a Positive Temperature Coefficient (PTC) heater. The PTC heater is being used as an auxiliary heating apparatus for compensating for heating performance of a vehicle in an existing gasoline (or diesel) vehicle.

However, when a heating apparatus (a PTC heater) is used for an electric vehicle which is driven by electrical energy stored in a battery to perform heating, the power of the battery is consumed, so that the traveling distance of the vehicle is reduced. Accordingly, in a fuel cell vehicle, the excessive consumption of power to heat the interior of the vehicle acts to reduce the fuel economy.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention, in preferred aspects, provides an air conditioning system for an electric vehicle and a method of controlling the air conditioning system which is configured to use heat emitted from a battery and a Motor Control Unit (MCU) (inverter) as heat for auxiliary heating during the driving of a vehicle, so that the heating of the interior of the vehicle is efficiently performed and, in particular, the consumption of battery power for the heating of the interior of the vehicle can be reduced, thereby suitably improving the traveling distance and fuel economy of the vehicle.

In a preferred embodiment, the present invention provides an air conditioning system for an electric vehicle including a blower for blowing air; a battery and a Motor Control Unit (MCU) that are suitably installed so as to be supplied with interior air drawn by the blower; and a controller for receiving detection signals from an interior temperature sensor, an exterior temperature sensor, a battery temperature sensor and an MCU temperature sensor and controlling the operation of the blower so that the battery and the MCU are suitably cooled by the interior air.

In another preferred embodiment, the present invention provides a method of controlling an air conditioning system for an electric vehicle, including operating a blower for blowing air; and, if the temperature of a battery and an MCU increase to a suitably high temperature equal to or higher than a preset temperature, suitably cooling the battery and the MCU by supplying the air, blown by the blower, to the battery and the MCU.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof through the accompanying drawings which are given hereinbelow by way of illustration only, and thus are not limitative of the present invention, and wherein:

FIG. 1 is a schematic diagram showing an air conditioning system for an electric vehicle according to an embodiment of the present invention;

FIG. 2 is a block diagram showing a configuration for controlling the air conditioning system according to an embodiment of the present invention;

FIG. 3 is a schematic diagram showing the circulation of interior air for heating the interior of a vehicle using the waste heat of the battery and the MCU in conjunction with FIG. 1;

FIG. 4 is a schematic diagram showing the circulation of air discharged to the outside after cooling the battery and the MCU in conjunction with FIG. 1;

FIG. 5 is a schematic diagram showing the circulation of interior air for heating the battery in conjunction with FIG. 1;

FIG. 6 is a flowchart showing a method of controlling an air conditioning system according to the embodiment of the present invention;

FIG. 7 is a graph showing the operation of the air conditioning system under a condition wherein the exterior temperature is not detected;

FIGS. 8 to 11 are graphs showing the operation of the air conditioning system under a condition wherein the exterior temperature is detected; and

FIGS. 12 and 13 are flowcharts showing a method of controlling an air conditioning system according to another embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

As described herein, the present invention features an air conditioning system for an electric vehicle comprising a blower for blowing air, a battery and a Motor Control Unit (MCU), and a controller.

In one embodiment, the battery and the Motor Control Unit (MCU) are installed to be supplied with interior air drawn by the blower.

In another embodiment, the controller receives detection signals from an interior temperature sensor, an exterior temperature sensor, a battery temperature sensor and an MCU temperature sensor and controls operation of the blower so that the battery and the MCU are cooled by the interior air.

In another aspect, the present invention features a method of controlling an air conditioning system for electric vehicle, comprising operating a blower, determining whether temperatures of a battery and an MCU are higher than a preset temperature, and if the temperatures of the battery and the MCU are higher than the preset temperature, introducing interior air and cooling the battery and the MCU using the interior air.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Embodiments of the present invention will be described in detail below with reference to the accompanying drawings so that those having ordinary skill in the technical field to which the present invention pertains.

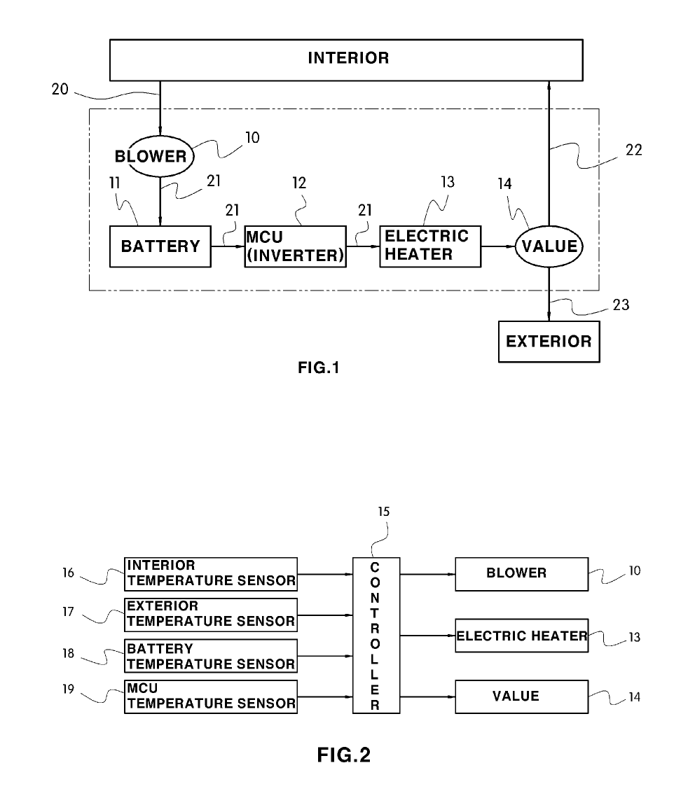

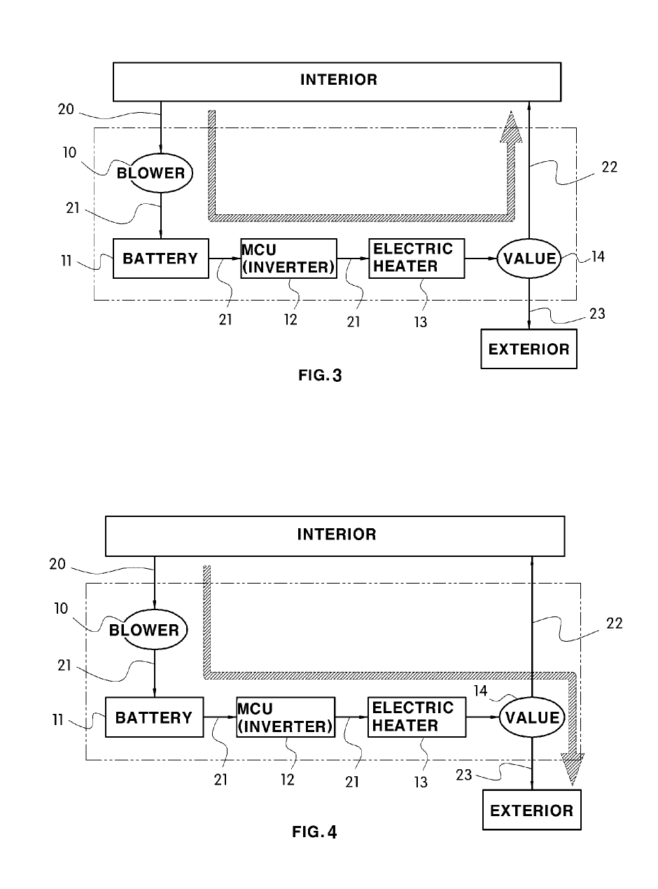

According to certain preferred embodiments and as shown FIG. 1 and FIG. 2, for example, FIG. 1 is a schematic diagram showing an air conditioning system for an electric vehicle, and FIG. 2 is a block diagram showing a preferred configuration for controlling the air conditioning system.

According to preferred embodiments of the present invention as described herein, the present invention is directed to an air conditioning system for an electric vehicle, such as a pure electric vehicle, a hybrid vehicle or a fuel cell vehicle, which is driven by operating an electric motor using electrical energy stored in a battery 11 or generated by a fuel cell.

In particular preferred embodiments, the air conditioning system according to the present invention is characterized by a heating apparatus which is capable of cooling and heating a battery 11 and an MCU 12 (an inverter) installed on a vehicle and, at the same time, heating the interior of the vehicle using the waste heat of the battery 11 and the MCU 12. Preferably, the air conditioning system according to the present invention can be usefully used for an electric vehicle using an electric heater 13 (a PTC heater), some other vehicle-mountable heater device, or an auxiliary heat exchanger for converting electrical energy into thermal energy, as an auxiliary interior heating apparatus for a winter season.

According to certain preferred embodiments, the air conditioning system of the present invention includes a blower 10, a battery 11, an MCU 12, an electric heater 13, a valve 14 and a controller 15.

In further preferred embodiments, the air conditioning system preferably includes a first circulation line 20 that is suitably configured to connect the interior of the vehicle with the blower 10 to receive interior air, a connection line 21 suitably configured to connect the blower 10, the battery 11, the MCU 12 and the valve 14 to each other, a second circulation line 22 suitably configured to connect the interior of the vehicle with the valve 14 to discharge air, received through the first circulation line 20, to the interior of the vehicle, and a discharge line 23 suitably configured to connect the valve 14 with the exterior of the vehicle to discharge air, received through the first circulation line 20.

Preferably, in certain exemplary embodiments, the blower 10 is suitably configured to change the direction of blowing and, therefore, may blow interior air to the battery 11 or blow air, transmitted from the battery 11, to the interior of the vehicle.

Preferably, the battery 11 is an electricity accumulation means which supplies power to an electric motor.

According to further preferred embodiments of the present invention, the MCU 12 changes the phase of power from the battery 11 in response to control signals from the controller 15, and then operates the electric motor.

The electric heater 13 is intended to compensate for insufficient heat in the auxiliary heating system of the present invention in such a way as to heat the interior of the vehicle by heating air using the waste heat of the battery 11 and the MCU 12, that is, preferably, heat emitted from the electric motor during the driving of the vehicle, and supplying the heated air to the interior of the vehicle.

Accordingly, in certain preferred embodiments of the present invention, when the battery 11 and the MCU 12 do not emit a suitable amount of heat in order to heat the interior because the temperatures of the battery 11 and the MCU 12 are not suitably high, that is, when the amounts of heat emitted by the battery 11 and the MCU 12 are insufficient, the target temperature of the interior of the vehicle is easily reached by additionally heating air primarily heated by the battery 11 and the MCU 12 using the electric heater 13 and supplying the additionally heated air to the interior of the vehicle.

Preferably, the valve 14 is suitably controlled such that it functions as a switching valve which suitably determines the direction of the flow of air, sets the path of air and compels air to flow only in a selected direction, or as a distribution valve which suitably distributes the amount of air by adjusting the amount of opening in each direction. For example, in certain preferred embodiments, a 3-way valve may be used as the valve 14.

In certain preferred embodiments of the present invention, the controller 15 suitably controls the operation of the blower 10 and the electric heater 13, and receives signals from an interior temperature sensor 16, an exterior temperature sensor 17, a battery temperature sensor 18 and an MCU temperature sensor 19 and controls the operation of the valve 14 based on the received signals.

Preferably, the controller 15 may be configured to control the On/Off of the blower 10, the rotating speed (the amount of blowing) of the blower 10 and the opening status of the valve 14 based on vehicle interior temperature, that is, in certain preferred embodiments defined as the detected temperature of the interior temperature sensor 16, outside air temperature, that is, in certain preferred embodiments defined as the detected temperature of the exterior temperature sensor 17, and the temperatures of the battery 11 and the MCU 12, that is, in certain preferred embodiments defined as the detected temperatures of the battery temperature sensor 18 and the MCU temperature sensor 19, or is configured to control the operation of the blower 10 in response to a user's manipulation of a switch.

A method of controlling an air conditioning system for an electric vehicle according to an embodiment of the present invention is described herein.

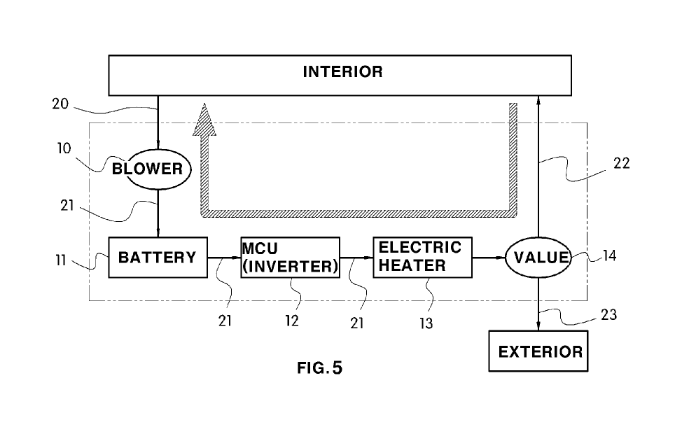

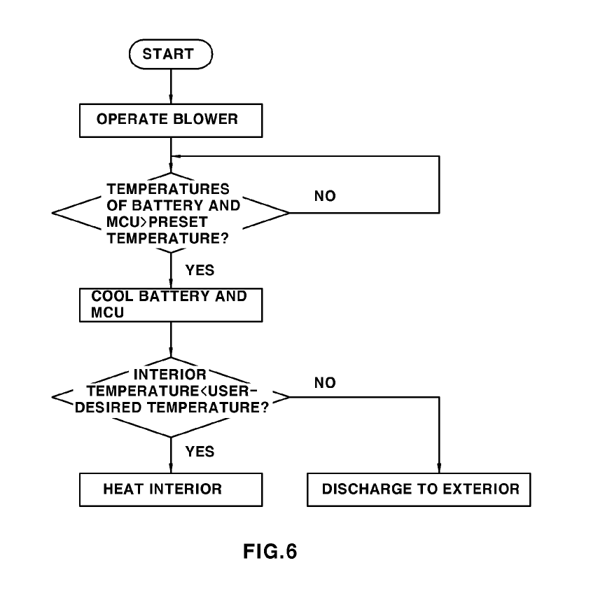

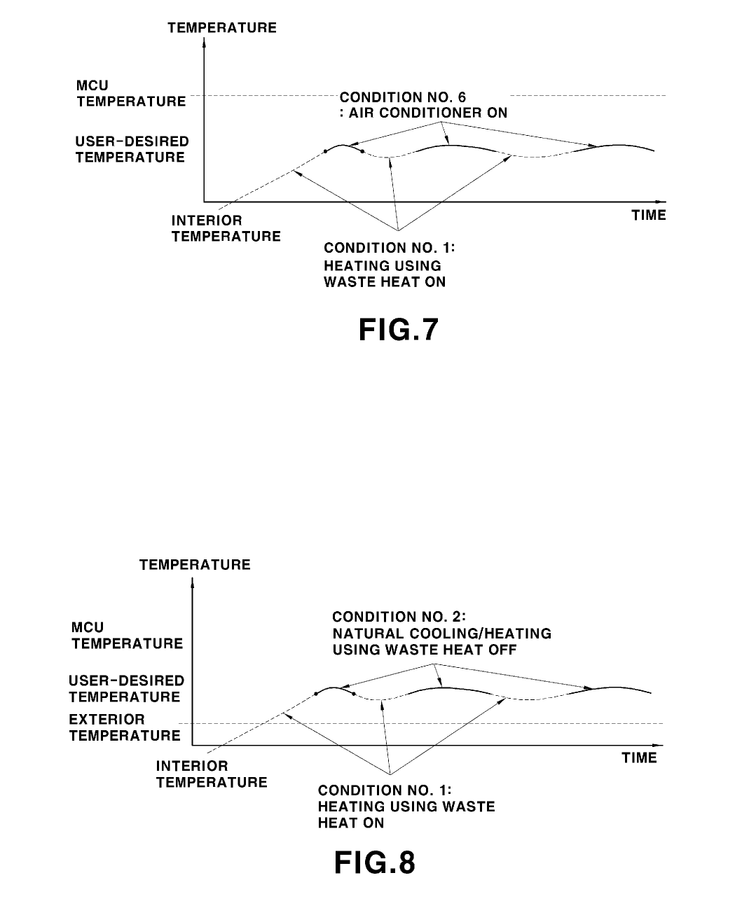

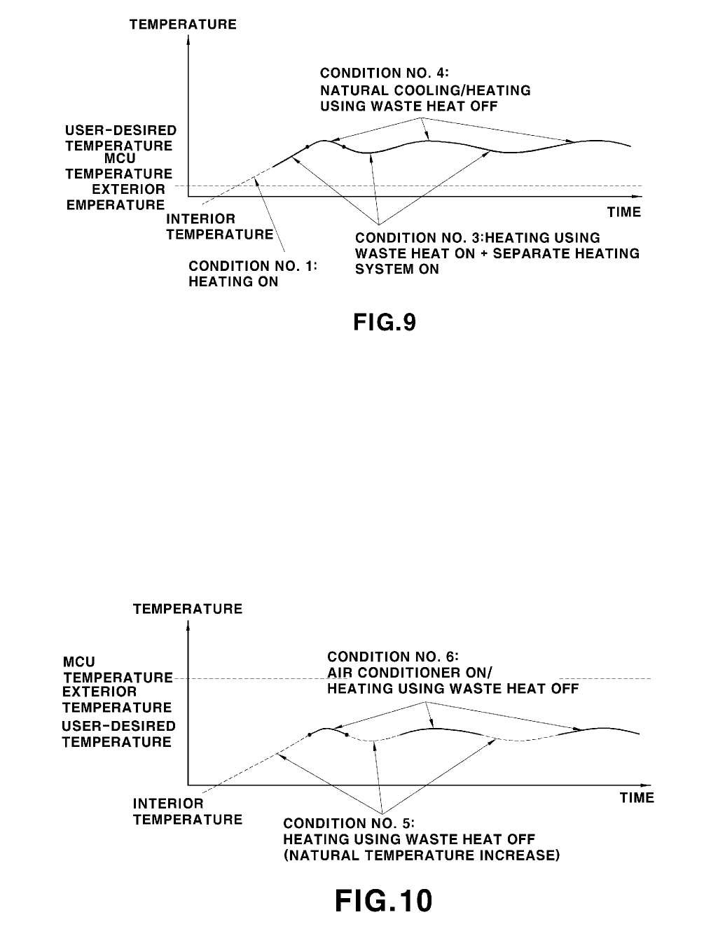

According to certain exemplary embodiments and as shown in FIG. 3 and FIG. 4, for example, FIG. 3 is a schematic diagram showing the circulation of interior air for heating the interior of the vehicle using the waste heat of the battery and the MCU in conjunction with FIG. 1, and FIG. 4 is a schematic diagram showing the circulation of air discharged to the outside after cooling the battery and the MCU in conjunction with FIG. 1. According to other exemplary embodiments and as shown in FIG. 5 and FIG. 6, for example, FIG. 5 is a schematic diagram showing the circulation of interior air for heating the batter in conjunction with FIG. 1, and FIG. 6 is a flowchart showing the method of controlling an air conditioning system according to another preferred embodiment of the present invention.

1. Cooling of Battery 11 and MCU 12

In one exemplary embodiment of the presence invention, first, the blower 10 is operated, and, if during the operation of a vehicle, the battery 11 and the MCU 12 heat up, the battery temperature sensor 18 and the MCU temperature sensor 19 detect the temperatures of the battery 11 and the MCU 12.

Thereafter, the controller 15 suitably receives detection signals from the battery temperature sensor 18 and the MCU temperature sensor 19, and suitably controls the blower 10 by sending a control signal to the blower 10 if the temperatures of the battery 11 and the MCU 12 are suitably determined to be higher than a preset temperature (a temperature higher than the interior temperature).

Preferably, as the blower 10 operates, interior air enters through the first circulation line 20, and cools the battery 11 and the MCU 12.

2. Interior Heating

Since air having passed through the battery 11 and the MCU 12 has absorbed heat from the battery 11 and the MCU 12, the temperature of the air is higher than that of the interior air.

In this case, according to a further preferred embodiment of the present invention, if heating is suitably determined to be necessary because interior temperature is low, for example, if the temperature detected by the interior temperature sensor 16 is 18° C. in the case where a set temperature desired by a user is 20° C., the controller 15 suitably adjusts the valve 14 to the interior of the vehicle, so that most of the air having passed through the battery 11 is sent to the interior of the vehicle.

Meanwhile, according to another further exemplary embodiment, if the interior temperature desired by a user is higher than that of the air having passed through the battery 11 and the MCU 12, for example, if the user-desired temperature is 20° C. and the temperatures of the battery 11 and the MCU 12 are 18° C. and are thus lower than the former temperature, the interior temperature is suitably increased by operating the electric heater 13, supplying air having passed through the battery 11 and the MCU 12 to the electric heater 13, additionally heating the air and supplying the heated air to the interior of the vehicle through the second circulation line 22.

However, in other certain exemplary embodiments, if heating is not required because the interior temperature is suitably higher than or equal to the required temperature set by the user, the controller 15 adjusts the valve 14 to the exterior of the vehicle, thereby suitably discharging the air having passed through the battery 11 to the outside through the discharge line 23.

3. Heating of Battery 11

According to another exemplary embodiment of the present invention, when the vehicle is ignited initially or is ignited in winter in cold conditions, the battery 11 has not been fully heated. Accordingly, in certain preferred embodiments, in order to heat the battery 11 to an appropriate temperature, interior air is made to enter through the second circulation line 22, is suitably heated by the electric heater 13, heats the battery 11 while passing over the MCU 12 and the battery 11 and is returned to the interior of the vehicle through the first circulation line 20 by adjusting the valve 14 to the interior of the vehicle and operating the blower 10 in a reverse direction.

Accordingly, by using the control method, interior air drawn by the blower 10 is sent to the high-temperature battery 11 and the high-temperature MCU 12, and then not only cools the battery 11 and the MCU 12 by heat exchange, but also deprives the battery 11 and the MCU 12 of high-temperature heat, thereby suitably heating the interior air of the vehicle.

Furthermore, when a vehicle is started in a cold winter season, the direction of blowing of the blower 10 is reversed, so that interior air drawn through the second circulation line 22 is heated while passing over the high-temperature electric heater 13 and heats the battery 11 while passing over the battery 11 and the MCU 12.

The present invention features methods of controlling an air conditioning system for an electric vehicle based on an exterior environment using the exterior temperature sensor 17 to detect the exterior temperature will be described below.

According to certain preferred embodiments, the exterior temperature sensor 17 measures the exterior temperature, the interior temperature sensor 16 measures the interior temperature of a vehicle, the battery temperature sensor 18 measures the temperature of the battery 11, the MCU temperature sensor 19 measures the temperature of the MCU 12, and the controller 15 receives signals from the exterior temperature sensor 17, the interior temperature sensor 16, the battery temperature sensor 18 and the MCU temperature sensor 19, and controls the air conditioning system of a vehicle.

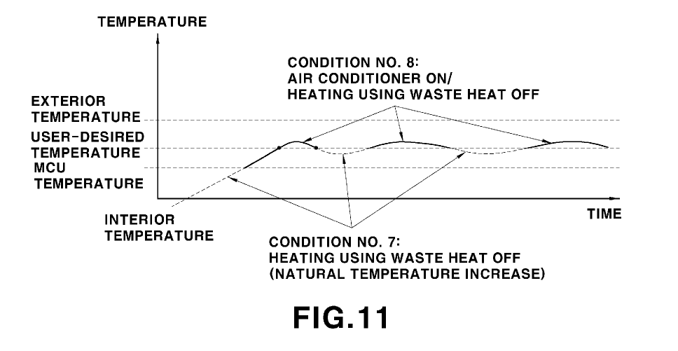

According to preferred exemplary embodiments and as shown in FIG. 7, for example, FIG. 7 is a graph showing the operation of the air conditioning system under the condition that the exterior temperature is not being suitably detected.

Preferably, if the air conditioning system is suitably controlled without detecting the exterior temperature using the exterior temperature sensor 17, abnormal operation and unnecessary operation may ensue.

For example, as shown in FIG. 7, when the interior temperature is suitably controlled without paying heed to the exterior temperature, the interior of the vehicle may be heated using the waste heat of the MCU 12 and the battery 11 if the interior temperature is equal to or lower than the user-desired temperature, and the interior temperature may be suitably decreased by operating the air conditioner if the interior temperature is higher than the user-desired temperature.

In other exemplary embodiments, when the interior temperature fluctuates around a user-desired temperature line, interior heating using the waste heat of the MCU 12 and the battery 11 or interior cooling using the air conditioner is repeated, so that excessive energy is consumed.

Preferably, when the exterior temperature sensor 17 is used, energy consumption can be suitably reduced by reducing the abnormal control of the air conditioning system for a vehicle and reducing unnecessary heating and operation of the air conditioner.

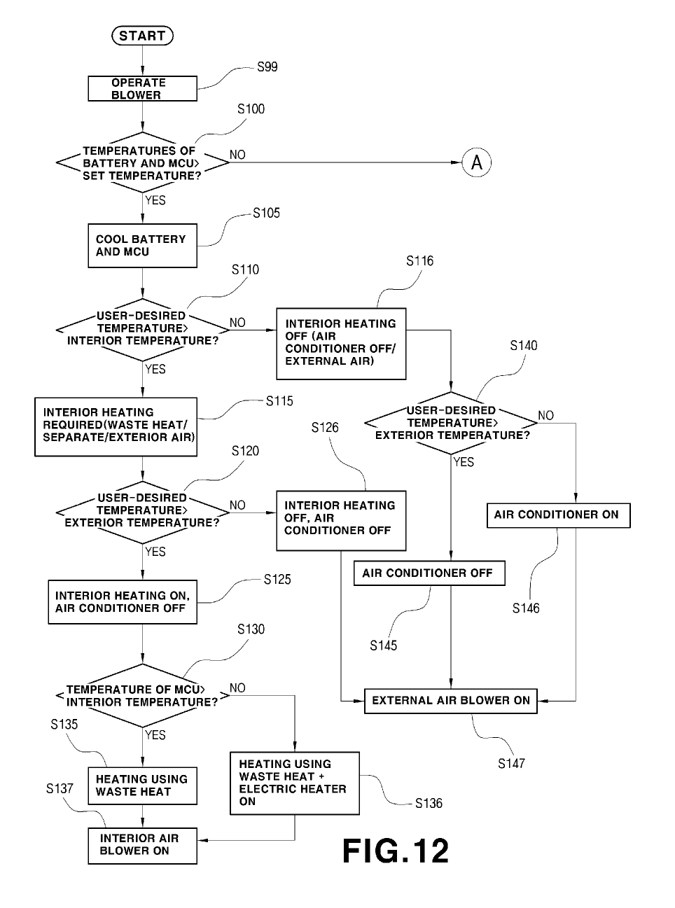

FIGS. 8 to 11 are graphs showing the operation of the air conditioning system under the condition of the exterior temperature being detected according to certain exemplary embodiments of the present invention.

The method of controlling the air conditioning system for a vehicle depending on exterior temperature conditions according to preferred exemplary embodiments is shown in Table 1, below:

TABLE 1

| | | | | | | | | Waste heat | |
|---|---|---|---|---|---|---|---|---|---|
| Condition | Temperature | User-desired | | Interior | Interior | | MCU | heating | Air |
| No. | condition | temperature | | temperature | temperature | | temperature | ON/OFF | conditioner |
| 1 | user-desired | target | ≧ | Interior | Interior | ≦ | MCU | ON | OFF |
| | temperature > exterior | temperature | | temperature | temperature | | temperature | | |
| | air temperature | | | | | | | | |
| 2 | user-desired | target | ≦ | Interior | Interior | ≦ | MCU | OFF | OFF |
| | temperature > exterior | temperature | | temperature | temperature | | temperature | | |
| | air temperature | | | | | | | | |
| 3 | user-desired | target | ≧ | Interior | Interior | ≧ | MCU | ON | OFF |
| | temperature > exterior | temperature | | temperature | temperature | | temperature | | |
| | air temperature | | | | | | | | |
| 4 | user-desired | target | ≦ | Interior | Interior | ≧ | MCU | OFF | OFF |
| | temperature > exterior | temperature | | temperature | temperature | | temperature | | |
| | air temperature | | | | | | | | |
| 5 | user-desired | target | ≧ | Interior | Interior | ≦ | MCU | OFF | OFF |
| | temperature > exterior | temperature | | temperature | temperature | | temperature | | |
| | air temperature | | | | | | | | |
| 6 | user-desired | target | ≦ | Interior | Interior | ≦ | MCU | OFF | ON |
| | temperature > exterior | temperature | | temperature | temperature | | temperature | | |
| | air temperature | | | | | | | | |
| 7 | user-desired | target | ≧ | Interior | Interior | ≧ | MCU | OFF | OFF |
| | temperature > exterior | temperature | | temperature | temperature | | temperature | | |
| | air temperature | | | | | | | | |
| 8 | user-desired | target | ≦ | Interior | Interior | ≧ | MCU | OFF | ON |
| | temperature > exterior | temperature | | temperature | temperature | | temperature | | |
| | air temperature | | | | | | | | |

The examples listed in Table 1 illustrate a variety of types of temperature conditions including, for example, cases where the user-desired temperature (also referred to as the “target temperature”) is higher than the exterior temperature (for example, in the summer) and cases where the user-desired temperature is equal to or lower than the exterior temperature (for example, in the winter).

1. A Condition of User-Desired Temperature>Exterior Temperature, User-Desired Temperature>Interior Temperature, and Interior Temperature<MCU Temperature

In certain exemplary embodiments, if the user-desired temperature is higher than the exterior temperature, and the interior temperature and the temperature of the MCU 12 is higher than the interior temperature, interior heating is determined to be required, and the interior temperature is suitably increased by introducing interior air at a relatively low temperature through the first circulation line 20, cooling the MCU 12 and suitably supplying the air, heated by the heat exchange with the MCU 12, to the interior of the vehicle (refer to FIG. 8).

2. A Condition of User-Desired Temperature>Exterior Temperature, User-Desired Temperature<Interior Temperature, and Interior Temperature<MCU Temperature

In certain exemplary embodiments, if the user-desired temperature is higher than the exterior temperature, the user-desired temperature is equal to or lower than the interior temperature and the interior temperature is equal to or lower than the temperature of the MCU 12, interior heating is determined to be required, the interior temperature is suitably controlled without requiring the operation of the air conditioner by turning off interior heating using waste heat and naturally cooling the interior of the vehicle using the exterior temperature which is relatively lower than the interior temperature (refer to FIG. 8).

Preferably, in this case, even when the windows of the vehicle are opened, exterior air enters into the vehicle, so that the interior temperature is decreased.

3. A Condition of User-Desired Temperature>Exterior Temperature, User-Desired Temperature>Interior Temperature, and Interior Temperature>MCU Temperature

In certain exemplary embodiments, if when the condition holds that the user-desired temperature is higher than the exterior temperature and the interior temperature and the interior temperature is higher than the temperature of the MCU 12, interior heating is determined to be required, heating using waste heat is turned on and a separate heating system, that is, the electric heater 13, is operated (refer to FIG. 9).

4. A Condition of User-Desired Temperature>Exterior Temperature, User-Desired Temperature<Interior Temperature, and Interior Temperature>MCU Temperature

In certain exemplary embodiments, if when the condition holds that the user-desired temperature is higher than the exterior temperature, the user-desired temperature is equal to or lower than the interior temperature and the interior temperature is higher than the temperature of the MCU 12, interior cooling is determined to be required, the interior temperature is suitably decreased without operating the air conditioner by introducing exterior air into the interior of the vehicle (refer to FIG. 9).

In this case, the interior temperature may be naturally decreased by heat exchange between the interior air and the exterior air at a temperature lower than that of the interior of the vehicle.

5. A Condition of User-Desired Temperature<Exterior Temperature, User-Desired Temperature>Interior Temperature, Interior Temperature<MCU Temperature

In certain exemplary embodiments, if when the condition holds that the user-desired temperature is or equal to or lower than the exterior temperature, the user-desired temperature is higher than the interior temperature and the interior temperature is equal to or lower than the temperature of the MCU 12, interior heating is determined to be required, and the interior of the vehicle may be suitably heated by turning off interior heating using waste heat and introducing exterior air at a temperature higher than the user-desired temperature into the interior of the vehicle (refer to FIG. 10).

Preferably, in certain preferred embodiments, the interior temperature is naturally increased by heat exchange between the interior air and the exterior air at a temperature higher than that of the interior air without requiring heating using waste heat or a separate heating system.

6. A Condition of User-Desired Temperature<Exterior Temperature, User-Desired Temperature<Interior Temperature, and Interior Temperature<MCU Temperature

In certain exemplary embodiments, if when the condition holds that the user-desired temperature is equal to or lower than the exterior temperature and the interior temperature and the interior temperature is equal to or lower than the temperature of the MCU 12, interior cooling is determined to be required, the interior temperature is suitably decreased by turning off interior heating using waste heat and operating the air conditioner (refer to FIG. 10).

7. A Condition of User-Desired Temperature<Exterior Temperature, User-Desired Temperature>Interior Temperature, and Interior Temperature>MCU Temperature

In certain exemplary embodiments, if when the condition holds that the user-desired temperature is lower than the exterior temperature, the user-desired temperature is higher than the interior temperature and the interior temperature is higher than the temperature of the MCU 12, interior heating is determined to be required, the interior temperature is adjusted by turning off interior heating using waste heat and suitably increasing the interior temperature using the exterior temperature higher than the user-desired temperature without requiring heating using waste heat or a separate heating system (refer to FIG. 11).

8. A Condition of User-Desired Temperature<Exterior Temperature, User-Desired Temperature<Interior Temperature, and Interior Temperature>MCU Temperature

In certain exemplary embodiments, if when the condition holds that the user-desired temperature is equal to or lower than the exterior temperature, the user-desired temperature is equal to or lower than the interior temperature and the interior temperature is higher than the temperature of the MCU 12, interior cooling is determined to be required, the interior temperature is suitably decreased by turning off interior heating using waste heat and operating the air conditioner (refer to FIG. 11).

According to preferred embodiments, the above phrase “turning off interior heating using waste heat” refers to turning off the blower 10, thereby preventing the interior air from being made to flow towards the battery 11 by the blower 10.

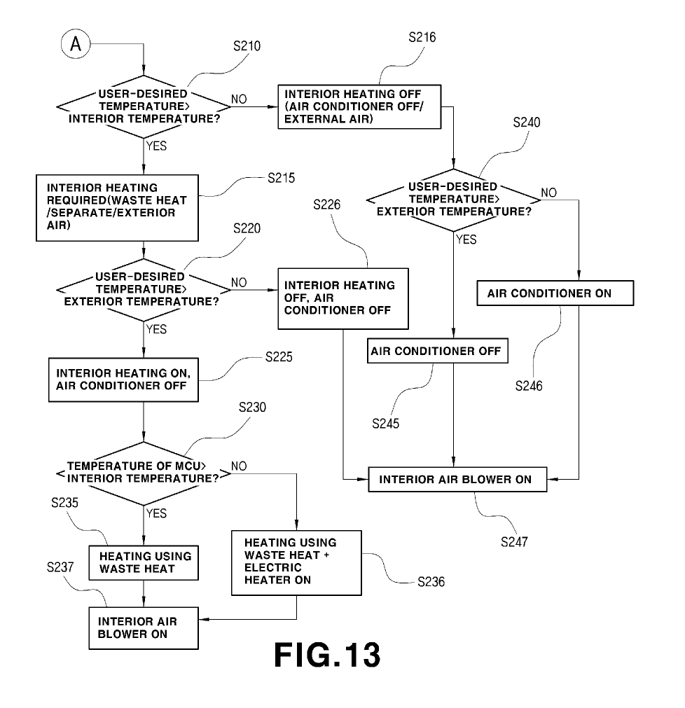

FIGS. 12 and 13 are flowcharts showing a method of controlling the air conditioning system according to another embodiment of the present invention.

Preferably, first, the blower 10 is operated at step S99.

Further, interior air is made to enter into the first circulation line 20 by the blower 10 at step S99.

Thereafter, whether the temperatures of the battery 11 and the MCU 12 are higher than a preset temperature is suitably determined at step S100.

Here, in preferred exemplary embodiments, the preset temperature refers to the temperature limit at which the battery 11 and the MCU 12 can perform their intrinsic functions. According to further exemplary embodiments, it is preferred that the temperatures of the battery 11 and the MCU 12 be suitably maintained at a temperature lower than the limit temperature because the temperature must not be increased to a temperature equal to or higher than the temperature limit. For example, the temperature limit may be 40° C.

Preferably, if the temperatures of the battery 11 and the MCU 12 are determined to be higher than the preset temperature at step S100, the process proceeds to step S105, where the interior air having entered through the first circulation line 20 cools the battery 11 and the MCU 12. In contrast, in other further exemplary embodiments, if the temperatures of the battery 11 and the MCU 12 are determined to be equal to or lower than the preset temperature at step S100, the process proceeds to steps S210˜S247.

Preferably, the process proceeds from step S105 to step S110, where whether the user-desired temperature is higher than the interior temperature is suitably determined.

Preferably, in further exemplary embodiments, if the user-desired temperature is determined to be higher than the interior temperature at step S110, the process proceeds to step S115, where interior heating is determined to be required. In contrast, in other further exemplary embodiments, if the user-desired temperature is equal to or lower than the interior temperature at step S110, the process proceeds to step S116, where interior heating is turned off.

After step S115, the interior temperature is suitably increased to the user-desired temperature using the waste heat of the MCU 12, the electric heater 13 or exterior air so as to perform interior heating depending on the condition of the exterior temperature and the temperature of the MCU 12. Further, after step S116, the interior temperature is suitably decreased to the user-desired temperature using the air conditioner or exterior air so as to perform interior cooling.

The steps of performing interior heating after step S115 are described herein below.

According to a preferred exemplary embodiment, whether the user-desired temperature is higher than the exterior temperature is suitably determined at step S120. A reason for this is to naturally increase the interior temperature using exterior air without requiring heating using waste heat or a separate electric heater 13 if the user-desired temperature is equal to or lower than the exterior temperature.

Preferably, if the user-desired temperature is determined to be suitably higher than the exterior temperature at step S120, the process proceeds to step S125, where interior heating is turned on and the air conditioner is turned off.

Accordingly, in this case, although exterior air is introduced into the interior of the vehicle, it is difficult to increase the interior of the vehicle to the user-desired temperature using exterior air because the exterior temperature is equal to or lower than the user-desired temperature. Preferably, if the interior temperature is higher than the exterior temperature, a problem arises in that the interior temperature is rather decreased by the introduction of the exterior air. Accordingly, if the user-desired temperature is determined to be higher than the exterior temperature at step S120, the process proceeds to step S125, where interior heating is turned on and the air conditioner is turned off.

Preferably, if the user-desired temperature is suitably determined to be equal to or lower than the exterior temperature at step S120, the process proceeds to step S126, where interior heating is turned off and the air conditioner is also turned off. Then the process proceeds to step S147, where an exterior air blower ON mode is performed.

In further exemplary embodiments, here, the exterior air blower ON mode implies that interior air passes over the battery 11, the MCU 12 and the electric heater 13 and is then suitably discharged to the outside from the valve 14 through the discharge line 23.

Accordingly, a reason why the interior heating is turned off is to naturally increase the interior temperature by introducing the exterior air into the interior of the vehicle or using the difference between the exterior temperature and the interior temperature without heating using waste heat or a separate electric heater 13.

For example, in certain preferred embodiments, if the exterior temperature is 30° C., the user-desired temperature is 20° C. and the interior temperature is 17° C. while the vehicle is parked in an underground parking lot in summer, the interior temperature will be naturally increased by the difference between the exterior temperature and the interior temperature even without turning on interior heating when the vehicle is moved from the underground parking lot and operated on the ground.

In further exemplary embodiments, after step S125, the process proceeds to step S130, where whether the temperature of the MCU 12 is higher than the interior temperature is suitably determined. A reason for this is to heat the interior of the vehicle using waste heat of the MCU 12 if the temperature of the MCU 12 is higher than the interior temperature.

A reason why only the temperature of the MCU 12 is taken into consideration is that the MCU 12 is generally heated to a temperature higher than that of the battery 11.

Accordingly, if the temperature of the MCU 12 is determined to be suitably higher than the interior temperature at step S130, the process proceeds to step S135, where the interior of the vehicle is heated using the waste heat of the MCU 12 by making interior air having entered through the first circulation line 20 exchange heat with the battery 11 and the MCU 12 and circulating the interior air, heated by the battery 11 and the MCU 12, to the interior of the vehicle using the valve 14.

Preferably, here, if the temperature of the MCU 12 is determined to be equal to or lower than the interior temperature at step S130, the process proceeds to step S136, where the waste heat of the MCU 12 is complemented by the heat of the electric heater 13 and thus the user-desired temperature is increased to the interior temperature by making the interior air exchange heat with the battery 11 and the MCU 12, operating the electric heater 13, heating the interior air using the electric heater 13, and circulating the heated interior air to the interior of the vehicle by adjusting the direction of the valve 14.

Preferably, in further embodiments, after step S135 and after step S136, the process proceeds to step S137. At step 137, turning on the blower 10 implies that interior air is suitably circulated through the first circulation line 20, the connection line 21 and the second circulation line 22 using the blower 10 and the valve 14.

Accordingly, the interior air cools the battery 11 and the MCU 12 and performs interior heating while circulating through the battery 11, the MCU 12 and the electric heater 13 after turning on the interior air blower 10.

Interior heating is turned off so as to decrease the interior temperature to the user-desired temperature at step S116, and the process proceeds to step S140, where whether the user-desired temperature is higher than the exterior temperature is determined.

A reason why the user-desired temperature is compared with the exterior temperature at step S140 is to suitably decrease the interior temperature using exterior air without using the air conditioner if the user-desired temperature is suitably higher than the exterior temperature.

Accordingly, in further preferred embodiments, if the user-desired temperature is higher than the exterior temperature at step S140, the process proceeds to step S145, where the interior temperature is naturally decreased by turning off the air conditioner or opening the windows of the vehicle or introducing exterior air into the interior of the vehicle.

For example, in certain exemplary embodiments, when exterior air is suitably introduced into the interior of the vehicle without the operation of the air conditioner if the exterior temperature is 10° C., the user-desired temperature is 20° C. and the interior temperature is 25° C. in winter, the interior air is naturally cooled by heat exchanged with the exterior air, so that the interior temperature drops to the user-desired temperature.

Preferably, after either step S145 or step S146, the process proceeds to step S147, where an exterior air blower ON mode is performed.

Preferably, when the exterior air blower ON mode is performed, interior air heated by the battery 11 and the MCU 12 is discharged to the outside by switching the direction of the valve 14 to the outside.

According to further exemplary embodiments, here, steps S100 to S147 correspond to the case where the temperatures of the battery 11 and the MCU 12 are higher than the set temperature. Accordingly, for example, if the MCU 12 is increased to a temperature higher than 40° C., the battery 11 and the MCU 12 are cooled using interior air, and control is performed in accordance with the following five exemplary cases, although it is understood that the invention is not limited as such:

1. In the case where interior heating is required and the user-desired temperature is higher than the exterior temperature, the interior of the vehicle is suitably heated using waste heat higher than a temperature of 40° C. emitted by the MCU 12.

2. In the case where the MCU 12 is cooled by interior air and the temperature of the MCU 12 is equal to or lower than the interior temperature, the interior of the vehicle is suitably heated using the electric heater 13.

3. In the case where interior heating is required and the user-desired temperature is equal to or lower than the exterior temperature, interior heating is turned off and the interior temperature is naturally increased using the exterior temperature.

4. In the case where interior cooling is required and the user-desired temperature is higher than the exterior temperature, the interior temperature is naturally cooled using the exterior temperature,

5. In the case where interior cooling is required and the user-desired temperature is equal to or lower than the exterior temperature, the air conditioner is turned on and cools the interior of the vehicle.

Meanwhile, in other certain preferred embodiments, if the temperatures of the battery 11 and the MCU 12 are determined to be equal to or less than the set temperature at step S100, the process proceeds to steps S210˜S247. In this case, since the temperatures of the battery 11 and the MCU 12 are equal to or less than the set temperature, heat at a temperature lower than that of waste heat emitted by the battery 11 and the MCU 12 at steps S100˜S147 is used.

Preferably, steps S210˜S247 are similar to steps S110˜S147, but steps S210˜S247 do not require the cooling of the battery 11 and the MCU 12 because the temperatures of the battery 11 and the MCU 12 are equal to or lower than the preset temperature unlike steps S100 and S105.

Furthermore, according to preferred exemplary embodiments, since steps S226, S245 and S246 do not require the cooling of the battery 11 and the MCU 12 or heating using waste heat, the process proceeds to step S247, where the blower 10 is turned off by performing an interior air blower OFF mode. Accordingly, interior air is not introduced into the first circulation line 20, is not supplied to the interior of the vehicle, or is not discharged to the outside by the blower 10, and the air conditioner is turned off and the interior temperature is naturally increased using exterior temperature at S245, or the air conditioner is turned on and the interior of the vehicle is cooled as at step S246.

Accordingly, according to the above control logic, if the temperatures of the battery and the MCU are higher than the set temperature, the battery 11 and the MCU 12 are cooled, and, at the same time, the interior of the vehicle may be heated using the waste heat of the MCU if the user-desired temperature is higher than the interior temperature.

According to exemplary embodiments of the present invention as described herein, if the temperatures of the battery 11 and the MCU 12 are equal to or lower than the set temperature but the user-desired temperature is higher than the interior temperature, the interior of the vehicle may be heated using the low-temperature waste heat of the MCU 12. Additionally, according to further embodiments as described herein, if interior heating is required, the user-desired temperature is compared with the exterior temperature, and, if the user-desired temperature is equal to or lower than the exterior temperature, interior heating is turned off and the interior temperature is naturally increased using the exterior temperature. In contrast, in other exemplary embodiments, if interior cooling is required, the user-desired temperature is compared with the exterior temperature, and, if the user-desired temperature is the same as the exterior temperature, interior heating is turned off and the interior temperature is naturally decreased. As a result, the unnecessary operation of the air conditioner and the heating system can be prevented, thereby conserving energy.

Preferably, in an air conditioning system for an electric vehicle and a method for controlling the same according to the present invention, while the vehicle is being driven, heat emitted by the battery and the MCU (inverter) can be used for auxiliary interior heating, so that heating can be efficiently performed and, in particular, the amount of battery power being consumed to heat the interior of the vehicle can be suitably reduced, thereby providing the advantages of improving the traveling distance and fuel economy of the vehicle.

In particular, there are certain advantages of the present invention in that the interior of the vehicle can be suitably heated effectively in the winter because the cooling of the battery and the MCU and an auxiliary heating function are simultaneously performed, and the efficiency is suitably increased by cooling the battery and the MCU.

Furthermore, there are certain advantages in that both the cooling of the battery and the MCU and the heating of the interior of the vehicle using heat emitted from the battery and the MCU can be suitably implemented using only a single blower which usually weighs a lot and is expensive, and in that the number of parts, weight and cost can be suitably reduced.

The invention has been described in detail with reference to preferred embodiments thereof. However, it will be appreciated by those skilled in the art that changes may be made to these embodiments without departing from the principles and spirit of the invention, the scope of which is defined in the appended claims and their equivalents.

What is claimed is:

1. An air conditioning system for an electric vehicle comprising:
a blower for blowing air;
a battery and a Motor Control Unit (MCU) installed to be supplied with interior air drawn by the blower; and
a controller for receiving detection signals from an interior temperature sensor, an exterior temperature sensor, a battery temperature sensor and an MCU temperature sensor and controlling operation of the blower so that the battery and the MCU are cooled by the interior air.

2. The system of claim 1, further comprising a valve which is controlled by the controller and which controls a flow direction and rate of the air so as to heat the interior air by circulating air having passed through the battery and the MCU to an interior or exterior of the vehicle.

3. The system of claim 1, further comprising an electric heater which is disposed between the MCU and the valve, and which performs auxiliary interior heating by heating air having passed through the MCU and circulating the air to an interior of the vehicle.

4. The system of claim 2, wherein the controller adjusts the valve to the interior of the vehicle so that the interior air heats the battery while passing over the battery.

5. A method of controlling an air conditioning system for electric vehicle, comprising:
operating a blower;
determining whether temperatures of a battery and an MCU are higher than a preset temperature; and
if the temperatures of the battery and the MCU are higher than the preset temperature, introducing interior air and cooling the battery and the MCU using the interior air.

6. The method of claim 5, further comprising:
after cooling the battery and the MCU, determining whether a user-desired temperature is higher than an interior temperature; and
if the user-desired temperature is higher than the interior temperature, heating an interior of the vehicle by supplying the interior air, heated by heat exchange with the battery and the MCU, to the interior of the vehicle.

7. The method of claim 6, wherein the heating the interior of the vehicle further comprises:
determining whether the temperature of the MCU is higher than the interior temperature; and
if the temperature of the MCU is higher than the interior temperature, heating the interior of the vehicle by additionally heating the interior air, heated while passing over the battery and the MCU, using an electric heater and then supplying the heated interior air to the interior of the vehicle again.

8. The method of claim 6, further comprising:
if the user-desired temperature is higher than the interior temperature, determining whether the user-desired temperature is higher than an exterior temperature; and
if the user-desired temperature is equal to or higher than the exterior temperature, turning off interior heating and naturally increasing the interior temperature using the exterior temperature.

9. The method of claim 6, further comprising, if the user-desired temperature is equal to or lower than the interior temperature, discharging the interior air having passed through the MCU from the interior of the vehicle.

10. The method of claim 6, further comprising:
if the user-desired temperature is equal to or lower than the interior temperature, turning off interior heating and determining whether the user-desired temperature is higher than the exterior temperature; and
if the user-desired temperature is equal to or lower than the exterior temperature, cooling the interior of the vehicle by turning on an air conditioner, and if the user-desired temperature is higher than the exterior temperature, naturally cooling the interior temperature using the exterior temperature.

11. The method of claim 5, further comprising:
if the temperatures of the battery and the MCU are equal to or lower than the preset temperature, determining whether the user-desired temperature is higher than the interior temperature;
if the user-desired temperature is higher than the interior temperature, determining whether the user-desired temperature is higher than an exterior temperature; and
if the user-desired temperature is equal to or lower than the exterior temperature, turning off interior heating and the blower and naturally increasing the interior temperature using the exterior temperature.

12. The method of claim 11, further comprising:
if the user-desired temperature is equal to or lower than the interior temperature, turning off interior heating and determining whether the user-desired temperature is higher than the exterior temperature;
if the user-desired temperature is higher than the exterior temperature, turning off the air conditioner and the blower and naturally increasing the interior temperature using the exterior temperature; and
if the user-desired temperature is equal to or lower than the exterior temperature, turning on the air conditioner and turning off the blower.

13. An air conditioning system for an electric vehicle comprising:
a blower for blowing air;
a battery and a Motor Control Unit (MCU); and
a controller.

14. The air conditioning system for an electric vehicle of claim 13, wherein the battery and the Motor Control Unit (MCU) are installed to be supplied with interior air drawn by the blower.

15. The air conditioning system for an electric vehicle of claim 13, wherein the controller receives detection signals from an interior temperature sensor, an exterior temperature sensor, a battery temperature sensor and an MCU temperature sensor and controls operation of the blower so that the battery and the MCU are cooled by the interior air.
